(19) United States
(12) Patent Application Publication
(10) Pub. No.: US 2026/0029317 A1
(43) Pub. Date: Jan. 29, 2026

(54) FLEXIBLE SUBSTRATE BENDING TEST APPARATUS

(71) Applicant: Samsung Display Co., LTD., Yongin-si (KR)

(72) Inventor: JAEBOK LEE, Yongin-si (KR)

(21) Appl. No.: 19/211,976

(22) Filed: May 19, 2025

(30) Foreign Application Priority Data
Jul. 23, 2024 (KR) 10-2024-0097097

(51) Int. Cl. G01N 3/20

(52) U.S. Cl. CPC G01N 3/20; G01N 2203/0023

(57) ABSTRACT

A flexible substrate bending test apparatus includes a first stage and a second stage which are driven independently of each other to be relatively movable, where each of the first stage and the second stage has a mounting surface on which a flexible substrate is mounted, a first extension part extending from an edge of the first stage, and a second extension part extending from an edge of the second stage. When the first stage and the second stage are in an unfolded state, a portion of the first extension part and a portion of the second extension part overlap each other in a direction perpendicular to the mounting surface of the first stage.

This application claims priority to Korean Patent Application No. 10-2024-0097097, filed on Jul. 23, 2024, and all the benefits accruing therefrom under 35 U.S.C. § 119, the content of which in its entirety is herein incorporated by reference.

### BACKGROUND

### 1. Field

This disclosure relates to a flexible substrate bending test apparatus.

### 2. Description of the Related Art

Recently, innovative uses of flexible glass have been attracting attention in various industrial fields. Flexible glass has thin thickness and excellent optical properties, so it is applied to high-end electronic products such as smartphones, wearable devices, and automobile displays. However, flexible glass has soft and pliable characteristics and is sensitive to bending or deformation, which can cause reliability problems. Therefore, the importance of bending tests is being highlighted in the manufacturing and application of flexible glass.

### SUMMARY

A different approach than traditional rigid substrates may be desired for testing flexible glass. Different types of test devices and methods may be desired for effective bending testing of flexible glass, which can verify the reliability of the product. Accordingly, the development of new devices and systems that can perform reliable bending tests considering the characteristics of flexible glass is recognized as an important task in the electronic product manufacturing field.

Embodiments are intended to provide a flexible substrate bending test apparatus with an expanded verification test range to ensure the strength of the bent portion of the flexible substrate.

A flexible substrate bending test apparatus according to an embodiment includes a first stage and a second stage which are separately driven to be relatively movable, where each of the first stage and the second stage has a mounting surface on which a flexible substrate is mounted, a first extension part extending from an edge of the first stage, and a second extension part extending from an edge of the second stage, where when the first stage and the second stage are in an unfolded state, a portion of the first extension part and a portion of the second extension part overlap each other in a direction perpendicular to the mounting surface of the first stage.

In an embodiment, the first extension part may be positioned vertically higher than the second extension part in the unfolded state.

In an embodiment, the first extension part may have a surface parallel to the mounting surface of the first stage.

In an embodiment, the second extension part may have an inclined surface forming an inclined angle with respect to the mounting surface of the second stage.

In an embodiment, the inclined surface may have a flat portion and a curved portion connected to each other.

In an embodiment, in the unfolded state, the first stage and the second stage may be positioned in a way such that the mounting surface of the first stage and the mounting surface of the second stage are on a same plane.

In an embodiment, the first extension part may be thinner than the first stage, and the extension part may be thinner than the second stage.

In an embodiment, in the unfolded state, a thickness of the first extension part may decreases as being toward the second stage, and a thickness of the second extension part may decreases as being toward the first stage.

In an embodiment, the first stage may include a side portion below the first extension part, and the second extension part may include an end portion in contact with the side portion in the unfolded state.

In an embodiment, the side portion may include a contact protrusion protruding outward, and an end side surface of the second extension part may define a contact groove in which the contact protrusion is disposed in the unfolded state.

In an embodiment, when the contact protrusion is disposed in the contact groove, the first extension part and the second extension part may be spaced apart from each other in a vertical direction.

In an embodiment, each of the first extension part and the second extension part may have an opposing surface facing each other in a direction crossing the mounting surface of the first stage.

In an embodiment, the first extension part may be shorter than the second extension part.

In an embodiment, the flexible substrate bending test apparatus may further include a first driver which moves the first stage in a first direction, a second driver which moves the first stage in a second direction perpendicular to the first direction, and a third driver which rotates the second stage around a rotation axis extending in a third direction perpendicular to a plane defined by the first and second directions.

A flexible substrate bending test apparatus according to an embodiment includes a first stage having a mounting surface on which a flexible substrate is mounted, a second stage having a mounting surface on which the flexible substrate is mounted and positioned adjacent to the first stage in an unfolded state, a first extension part extending from an edge of the first stage toward the second stage in the unfolded state, a second extension part extending from an edge of the second stage toward the first stage in the unfolded state, and an actuator which drives the first stage and the second stage to move with respect to each other, and in the unfolded state, the first extension part and the second extension part have a portion facing each other in a direction crossing the mounting surface of the first stage.

In an embodiment, the first extension part may be positioned vertically higher than the second extension part in the unfolded state.

In an embodiment, the first extension part may have a surface parallel to the mounting surface of the first stage.

In an embodiment, the second extension part may have an inclined surface forming an inclined angle with respect to the mounting surface of the second stage.

In an embodiment, the first stage and the second stage may be positioned in a way such that the mounting surface of the first stage and the mounting surface of the second stage are on a same plane in the unfolded state.

In an embodiment, the actuator may include a linear motion driver which relatively moves the first stage or the second stage in a first direction or a second direction perpendicular to each other, and a rotational motion driver which rotates the first stage or the second stage about a rotation axis extending in a third direction perpendicular to a plane defined by the first and second directions.

According to embodiments, the strength of the bent portion of the flexible substrate desired in various sizes maybe be guaranteed by having a more expanded verification test range.

In such embodiments, by having an expanded sliding test range, the reliability of flexible substrate bending tests can be secured.

### BRIEF DESCRIPTION OF THE DRAWINGS

FIG. 1 is a perspective view schematically showing a state in which a flexible substrate is placed on first and second stages of a flexible substrate bending test apparatus according to an embodiment.

FIG. 2 is a front view of FIG. 1.

FIG. 3 to FIG. 5 are front views schematically showing the process of bending and sliding a flexible substrate by driving first and second stages of the flexible substrate bending test apparatus shown in FIG. 1.

FIG. 6 is a perspective view showing a flexible substrate bending test apparatus according to an embodiment.

FIG. 7 is an exploded perspective view showing both stages mounted on the flexible substrate bending test apparatus shown in FIG. 6.

FIG. 8 is a front view showing the flexible substrate seated in a state in which first and second stages of the flexible substrate bending test apparatus shown in FIG. 7 are coupled and unfolded.

FIG. 9 is a diagram illustrating a folding operation in which first and second stages of the flexible substrate bending test apparatus shown in FIG. 8 are driven to fold.

FIG. 10 is a diagram illustrating a state in which first and second stages of the flexible substrate bending test apparatus shown in FIG. 8 press the flexible substrate for a bending test.

FIG. 11 is a diagram illustrating a process for performing a bending test on a flexible substrate using a flexible substrate bending test apparatus according to an embodiment.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

In order to clearly explain the present disclosure, parts that are not relevant to the description are omitted, and identical or similar components are assigned the same reference numerals throughout the specification.

In addition, the size and thickness of each component shown in the drawings are arbitrarily shown for convenience of explanation, so the present disclosure is not necessarily limited to that which is shown. In the drawing, the thickness is enlarged to clearly express various layers and areas. And in the drawings, for convenience of explanation, the thicknesses of some layers and regions are exaggerated.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

In addition, throughout the specification, when reference is made to “on a plane,” this means when the target part is viewed from above, and when reference is made to “in a cross-section,” this means when a cross-section of the target portion is cut vertically and viewed from the side.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

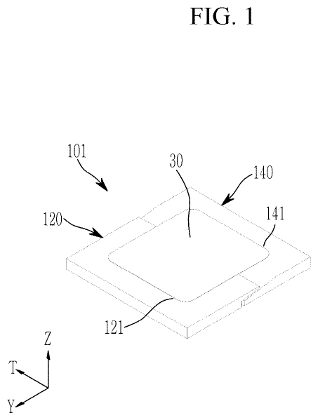

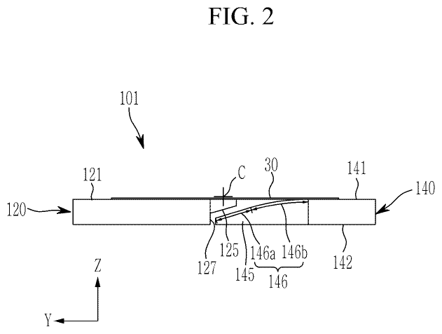

FIG. 1 is a perspective view schematically showing a state in which a flexible substrate is placed on first and second stages of a flexible substrate bending test apparatus according to an embodiment, and FIG. 2 is a front view of FIG. 1.

Referring to FIG. 1, the flexible substrate bending test apparatus 101 according to an embodiment includes a first stage 120 and a second stage 140 that are separated from each other and individually driven (or driven independently of each other). The first stage 120 and the second stage 140 may be located respectively on both opposing sides with respect to a central axis C of rotation for bending in an unfolded state. In the unfolded state, one edge of the first stage 120 and one edge of the second stage 140 may be located adjacent to each other. Here, the “unfolded state” is a state in which the mounting surfaces (e.g., uppermost surfaces) 121 and 141 of the first stage 120 and the second stage 140 are parallel to each other and on a same plane.

The central axis C of rotation for bending may extend in a direction parallel to adjacent edges of the first stage 120 and the second stage 140. The central axis C of rotation for bending may be the central axis of movement where the first stage 120 and the second stage 140 move relative to each other and the respective mounting surfaces 121 and 141 are rotated or folded to face each other. The second stage 140 may be rotated around the central axis C and positioned on the first stage 120 in an inverted state. In the inverted state, the mounting surface 121 of the first stage 120 and the mounting surface 141 of the second stage 140 may be positioned to face each other.

Each of the first stage 120 and the second stage 140 may have mounting surfaces 121 and 141 on which a flexible substrate 30 is seated. The flexible substrate 30 may be mounted across the mounting surface 121 of the first stage 120 and the mounting surface 141 of the second stage 140. When in the unfolded state, the mounting surface 121 of the first stage 120 and the mounting surface 141 of the second stage 140 may define be on a same plane, such the flexible substrate 30 may be seated in an unfolded state on a substantially planar surface on the plane.

The flexible substrate 30 may include curved, bended, foldable, slidable, rollable, or stretchable materials. In an embodiment, for example, the flexible substrate 30 may include flexible glass, ultra-thin glass (UTG), high-temperature glass (HTG), or the like.

Referring to FIG. 2, in an embodiment, a first extension part 125 may extend from the first stage 120, and a second extension part 145 may extend from the second stage 140. The first extension part 125 may extend from one edge of the first stage 120 adjacent to the second stage 140, and in an unfolded state, the first extension part 125 may extend towards the second stage 140. The second extension part 145 may extend from one edge of the second stage 140 adjacent to the first stage 120, and in the unfolded state, the second extension part 145 may extend towards the first stage 120.

The first extension part 125 may be thinner than the thickness of the first stage 120, and the second extension part 145 may be thinner than the thickness of the second stage 140. In the unfolded state, the thickness of the first extension part 125 may decrease as it approaches (as being towards) the second stage 140, and the thickness of the second extension part 145 may decrease as it approaches (as being towards) the first stage 120. That is, the first extension part 125 and the second extension part 145 may have a shape that tapers toward the outside based on thickness. Here, the thickness may be the distance between the upper and lower surfaces measured along the vertical direction (Z-axis direction in the drawing).

When the first stage 120 and the second stage 140 are unfolded, the first extension part 125 and the second extension part 145 may be positioned to face each other along a direction that intersects with the mounting surface 121 of the first stage 120. In an embodiment, the second extension part 145 may have an inclined surface 146 that is at an inclined angle with respect to the mounting surface 141 of the second stage 140. In such an embodiment, the inclined surface 146 of the second extension part 145 may include a flat portion 146a and a curved portion 146b connected to each other. The flat portion 146a of the inclined surface 146 may be a portion parallel to the opposing surface of the first extension part 125. The curved portion 146b of the inclined surface 146 may be located between the flat portion 146a and the mounting surface 141 of the second stage 140 and may have a preset curvature.

When viewed from above the mounting surface 121 of the first stage 120 (in a plan view or when viewed in the Z-axis direction), the first extension part 125 and the second extension part 145 may be positioned to partially overlap each other. The first extension part 125 may disposed above the second extension part 145, i.e., positioned higher in the vertical direction than the second extension part 145. In the length along the horizontal direction perpendicular to the vertical direction (Y-axis direction in the drawing), the first extension part 125 may be shorter than the second extension part 145.

The first extension part 125 has a surface parallel to (e.g., on a same plane as) the mounting surface 121 of the first stage 120, and the second extension part 145 may have a surface parallel to (e.g., on a same plane as) the bottom surface 142 of the second stage 140. The mounting surface 121 of the first stage 120 and the mounting surface 141 of the second stage 140 are positioned to define a same plane in the unfolded state. in an embodiment, the first stage 120 includes a side part 127 below the first extension part 125, and in the unfolded state, the end of the second extension 145 may be positioned to face the side part 127 of the first stage 120.

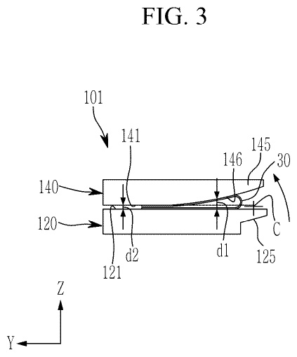

FIG. 3 to FIG. 5 are front views schematically showing a process of bending and sliding a flexible substrate by driving first and second stages of the flexible substrate bending test apparatus shown in FIG. 1.

Referring to FIG. 3, in the flexible substrate bending test apparatus 101 according to an embodiment, the first stage 120 and the second stage 140 may be driven relative to each other in a way such that the mounting surface 121 of the first stage 120 and the mounting surface 141 of the second stage 140 are positioned to face each other and to be in parallel with each other. The second stage 140 may rotate around the central axis C for bending, and when the second stage 140 rotates, the part of the flexible substrate 30 that is seated on the mounting surface 141 of the second stage 140 also rotates, thereby allowing the flexible substrate 30 to be bent.

In the state where the mounting surfaces 121, 141 face each other to be in parallel with each other, a gap distance (e.g., an average gap distance) d1 between the inclined surface 146 of the second extension part 145 and the mounting surface 121 of the first stage 120 is greater than a gap distance d2 between the mounting surface 141 of the second stage 140 and the mounting surface 121 of the first stage 120. The bent portion of the flexible substrate 30 is positioned between the inclined surface 146 of the second extension part 145 and the mounting surface 121 of the first stage 120.

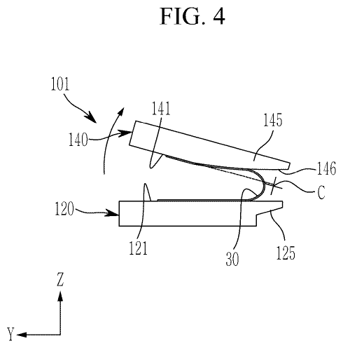

Referring to FIG. 4, the first stage 120 and the second stage 140 may be driven relative to each other in a way such that the mounting surface 121 of the first stage 120 and the inclined surface 146 of the second extension 145 are positioned to face each other in a parallel state. Here, the inclined surface 146 of the second extension part 145 may be positioned to face the upper surface of the first extension part 125 in a state where the inclined surface 146 (e.g., the flat portion 146a) of the second extension part 145 and the upper surface of the first extension part 125 are also parallel to each other. The second stage 140 may be rotated again around the central axis C for bending, and at this time, the separation distance (e.g., an averages separation distance) between the mounting surface 121 of the first stage 120 and the mounting surface 141 of the second stage 140 becomes greater than the separation distance (e.g., an averages separation distance) between the inclined surface 146 of the second stage 140 and the mounting surface 121 of the first stage 120.

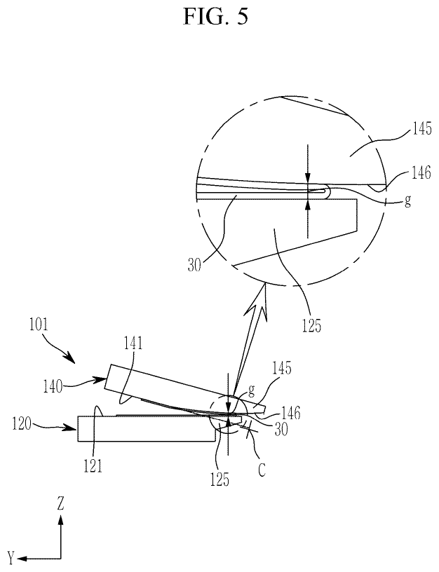

Referring to FIG. 5, the first stage 120 and the second stage 140 may be driven relative to each other in a way such that the separation distance between the mounting surface 121 of the first stage 120 and the inclined surface 146 of the second extension 145 becomes closer or less. The separation distance may be maintained as a gap g according to (determined based on) the verification standard for the bending test of the flexible substrate 30. In an embodiment, for example, the gap g according to the verification standard may be about 1.8 millimeter (mm). However, it is not limited to this, and may be set differently depending on the type of flexible substrate 30, the type of bending test, the inspection range, or the like.

In the state shown in FIG. 4, the first stage 120 and the second stage 140 may be driven relative to each other to set the horizontal position (Y-axis direction in the drawing) of the first stage 120. Accordingly, the inspection portion of the flexible substrate 30 may be selected. Then, as shown in FIG. 5, the bending test of the flexible substrate 30 may be performed by raising the first stage 120 while narrowing (or decreasing) the gap thereof with the second stage 140.

The relative driving of the first stage 120 and the second stage 140 will hereinafter be described referring to FIGS. 3 to 5. In an embodiment, the first stage 120 may be moved in the horizontal direction (Y-axis direction) and the vertical direction (Z-axis direction), and the second stage 140 may be rotated around the rotation axis (T-axis shown in FIG. 1). That is, as shown in FIG. 3, the second stage 140 may be positioned by rotating about 180 degrees around the T-axis. In FIG. 4, the first stage 120 may be lowered in the Z-axis direction and the second stage 140 may be positioned by rotating about 160 degrees around the T-axis. In FIG. 5, the first stage 120 may be positioned by raising a position thereof in the Z-axis direction. However, the driving method for relative driving of the first stage 120 and the second stage 140 is not limited to this and may be combined in various ways depending on the selection of the actuator.

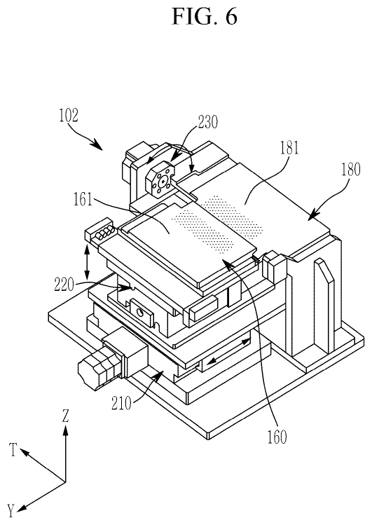

FIG. 6 is a perspective view showing a flexible substrate bending test apparatus according to an embodiment.

Referring to FIG. 6, the flexible substrate bending test apparatus 102 according to an embodiment includes a first stage 160 and a second stage 180, and further includes, as actuators for driving the first stage 160 and the second stage 180, a first driver 210, a second driver 220, and a third driver 230.

The first stage 160 and the second stage 180 may be driven separately from each other (or independently of each other) to enable relative movement, and each has a mounting surface 161 or 181 on which the flexible substrate 30 is seated.

The first driver 210 may move the first stage 160 in a first direction. The first direction may be a horizontal direction (Y-axis direction). The second driver 220 may move the first stage 160 in a second direction. The second direction may be a vertical direction (Z-axis direction) perpendicular to the first direction. The third driver 230 may rotate the second stage 180 about a rotation axis (T-axis) in a third direction. The third direction may be perpendicular to the first and second directions or a plane defined by the first and second directions. In an embodiment, the first driver 210 and the second driver 220 may be linear motion drivers, and the third driver 230 may be a rotational motion driver.

The first stage 160 may be positioned and fixed on the second driver 220, and the second driver 220 may be positioned and fixed on the first driver 210. Therefore, when driving the first driver 210, the second driver 220 and the first stage 160 may move together.

The second stage 180 may be positioned and fixed on the third driver 230. The third driver 230 may set the relative bending angle of the second stage 180 with respect to the first stage 160 by rotating the second stage 180 about the rotation axis (T-axis).

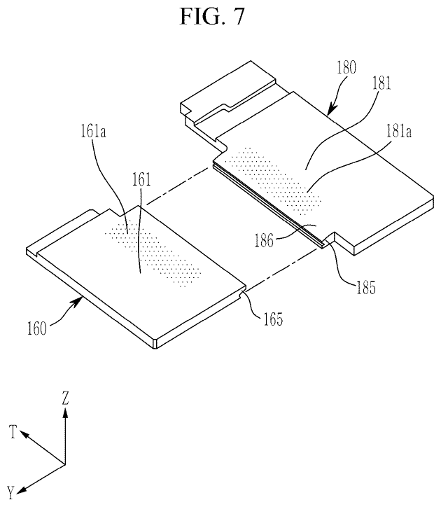

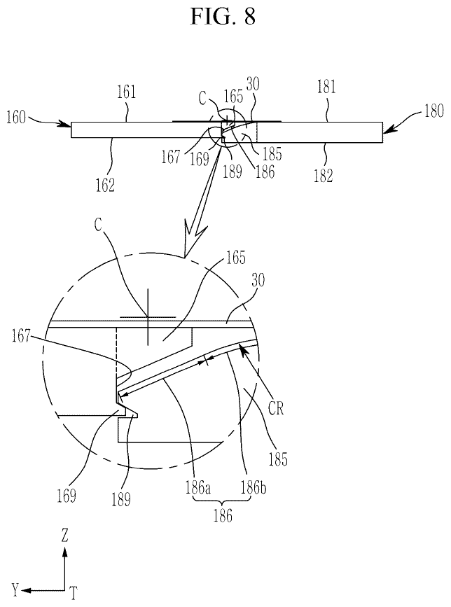

FIG. 7 is an exploded perspective view showing first and second stages mounted on the flexible substrate bending tester shown in FIG. 6, and FIG. 8 is a front view showing the flexible substrate seated in the unfolded state with first and second stages of the flexible substrate bending tester shown in FIG. 7 combined.

Referring to FIGS. 7 and 8, the first stage 160 and the second stage 180 may be located respectively on opposing sides with respect to the central axis C of rotation for bending in the unfolded state. In the unfolded state, one edge of the first stage 160 and one edge of the second stage 180 may be located adjacent to each other.

Each of the first stage 160 and the second stage 180 may have mounting surfaces 161 and 181 on which the flexible substrate 30 is seated. The flexible substrate 30 may be seated over the mounting surface 161 of the first stage 160 and the mounting surface 181 of the second stage 180. When in the unfolded state, the mounting surface 161 of the first stage 160 and the mounting surface 181 of the second stage 180 may be on a same plane, such the flexible substrate 30 may be seated in an unfolded state on a planar surface on the plane.

The flexible substrate 30 may be fixed not to slide on the stage when placed on the mounting surface 161 of the first stage 160 and the mounting surface 181 of the second stage 180. In an embodiment, for example, the flexible substrate 30 may be fixed by vacuum suction from below the stage through suction holes 161a and 181a defined or formed in each of the first stage 160 and the second stage 180. The suction holes 161a and 181a may be formed by penetrating each of the first stage 160 and the second stage 180 in the thickness direction. Furthermore, suction holes may be similarly provided to the stages according to the embodiment described with reference to FIGS. 1 to 5. Since the vacuum adsorption method may be implemented with known structures and methods, detailed illustrations and descriptions are omitted here.

Referring to FIG. 8, in an embodiment, the first extension part 165 may extend from the first stage 160, and the second extension part 185 may extend from the second stage 180. The first extension part 165 may extend from one edge of the first stage 160 adjacent to the second stage 180, and in the unfolded state, the first extension part 165 may extend towards the second stage 180. The second extension part 185 may extend from one edge of the second stage 180 adjacent to the first stage 160, and in the unfolded state, the second extension part 185 may extend towards the first stage 160.

The first extension part 165 may be thinner than the thickness of the first stage 160, and the second extension part 185 may be thinner than the thickness of the second stage 180. In an unfolded state, the thickness of the first extension part 165 may decrease as it approaches (or as being towards) the second stage 180, and the thickness of the second extension part 185 may decrease as it approaches (or as being towards) the first stage 160. That is, the first extension part 165 and the second extension part 185 may have a shape that tapers toward the outside with respect to thickness.

When the first stage 160 and the second stage 180 are deployed, the first extension part 165 and the second extension part 185 may be positioned to face each other along the direction crossing with the mounting surface 161 of the first stage 160. The second extension part 185 may have an inclined surface 186 having an inclined angle with respect to the mounting surface 181 of the second stage 180. In an embodiment, the inclined surface 186 of the second extension part 185 may include a flat portion 186a and a curved portion 186b connected to each other. The flat portion 186a of the inclined surface 186 may be a flat surface facing the first extension part 165.

The curved portion 186b of the inclined surface 186 may be located between the flat portion 186a and the mounting surface 181 of the second stage 180, and may have a preset curvature around an axis parallel to the T-axis. The curvature radius CR of the curved portion 186b may be designed differently depending on the test range or sliding range of the flexible substrate bending test apparatus 102. When the radius of curvature CR of the curved portion 186b is small, the length of the flat portion 186a of the inclined surface 186 becomes longer, such the test range or sliding range may also become longer.

In an embodiment, for example, the radius of curvature CR of the curved portion 186b of the inclined surface 186 may be in a range of 60R to 120R. That is, the radius of curvature CR may be in a range of about 60 mm to about 120 mm. When radius of curvature CR is less than 60R, the curved portion 186b is too short and may damage the flexible substrate. When the radius of curvature CR of the curved portion 186b exceeds 120R, the flat portion 186a of the inclined surface 186 becomes shorter, such that the test range or sliding range may be decreased, thereby making it difficult to expect improvement compared to a case without the first extension part 165 and the second extension part 185. In a case where the first extension part 165 and the second extension part 185 are further lengthened to compensate to increase the test range of sliding range, the first extension part 165 and the second extension part 185 may collide with the first stage 160 when the second stage 180 rotates.

When viewed from the mounting surface 161 of the first stage 160 (i.e., when viewed in a plan view or in the Z-axis direction), the first extension part 165 and the second extension part 185 may be positioned to partially overlap each other. The first extension part 165 may be positioned vertically higher than the second extension part 185. In the length along the horizontal direction perpendicular to the vertical direction, the first extension part 165 may be shorter than the second extension part 185. In addition, the first extension part 165 may have a surface parallel to the mounting surface 161 of the first stage 160, and the second extension part 185 may have a surface parallel to the bottom surface 182 of the second stage 180.

The first stage 160 may include a side portion 167 below the first extension part 165, and in an unfolded state, the end of the second extension part 185 may be positioned to face the side portion 167 of the first stage 160.

The side portion 167 of the first stage 160 may include a contact protrusion 169 protruding outward. The end of the second extension part 185 may define a contact groove 189 that may accommodate the contact protrusion 169 therein. Therefore, when the contact protrusion 169 is received in the contact groove 189, the contact protrusion 169 comes into contact with the inner surface of the contact groove 189, such that the first extension part 165 and the second extension part 185 may be maintained spaced apart from each other in the vertical direction. In such an embodiment, in an unfolded state, the positions of the first stage 160 and the second stage 180 may be maintained constant, and undesired contact between different portions of the first extension part 165 and the second extension part 185 during operation may be effectively prevented.

The thickness of the second stage 180 may be greater than the thickness of the first stage 160. The mounting surfaces 161 and 181 of each of the first stage 160 and the second stage 180 are positioned to be on a same plane with each other in an unfolded state, such that the flexible substrate 30 may be stably mounted thereon. Accordingly, the bottom surface 182 of the second stage 180 may be positioned lower than the bottom surface 162 of the first stage 160.

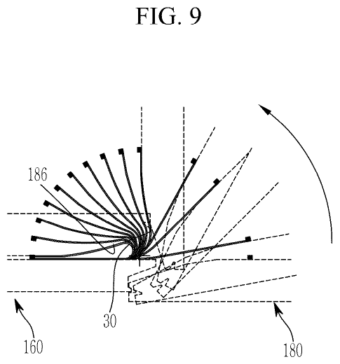

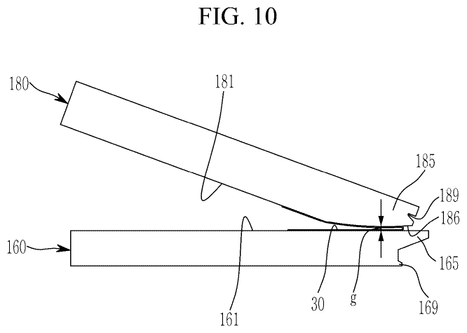

FIG. 9 is a drawing showing a folding operation in which first and second stages of the flexible substrate bending test apparatus shown in FIG. 8 are driven to fold, and FIG. 10 is a drawing showing the state where first and second stages of the flexible substrate bending test apparatus shown in FIG. 8 press the flexible substrate for the bending test.

Referring to FIG. 9, in the flexible substrate bending test apparatus 102 according to an embodiment, the first stage 160 and the second stage 180 may be driven relative to each other in a way such that the mounting surface 161 of the first stage 160 and the mounting surface 181 of the second stage 180 face each other in parallel.

The second stage 180 may be rotated about 180 degrees around the central axis (T-axis) by driving the third driver 230. Here, the portion of the flexible substrate 30 mounted on the mounting surface 181 of the second stage 180 may be bent while rotating together.

When the mounting surfaces 161 and 181 face each other in parallel, the separation distance (e.g., an averages separation distance) between the inclined surface 186 of the second extension part 185 and the mounting surface 161 of the first stage 160 is greater than the separation distance (e.g., an averages separation distance) between the mounting surface 161 of the first stage 160 and the mounting surface 181 of the second stage 180. The bent portion of the flexible substrate 30 is positioned between the inclined surface 186 of the second extension part 185 and the mounting surface 161 of the first stage 160.

Referring to FIG. 10, by relatively driving the first stage 160 and the second stage 180, the mounting surface 161 of the first stage 160 and the inclined surface 186 of the second extension part 185 may face each other in parallel, allowing the distance therebetween to be reduced. The first stage 160 may be lowered vertically (in the Z-axis direction) by driving the second driver 220, the second stage 180 may be rotated about the rotation axis (T-axis) by driving the third driver 230, and the first stage 160 may be raised vertically (in the Z-axis direction) by driving the second driver 220 again.

The separation distance between the mounting surface 161 of the first stage 160 and the inclined surface 186 of the second stage 180 may be maintained as the gap (g) according to the verification standard for the bending test of the flexible substrate 30. In an embodiment, for example, the gap (g) according to the verification standard may be about 1.8 mm. However, it should not be limited to this, and may be set differently depending on the type of flexible substrate 30, type of bending test, test range, etc.

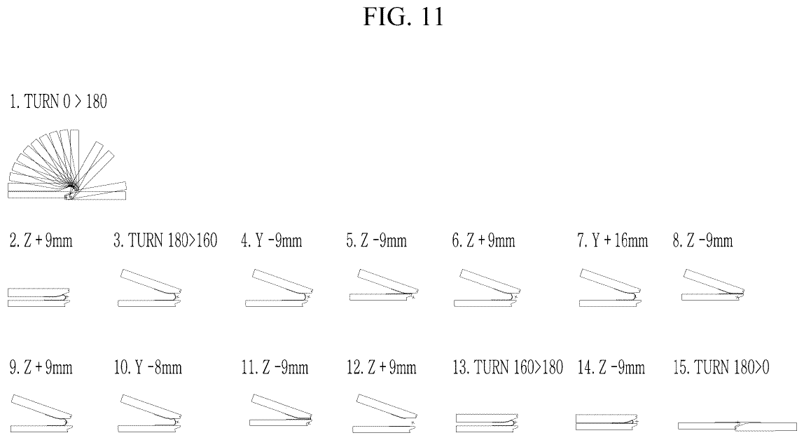

FIG. 11 is a diagram illustrating a process for performing a bending test on a flexible substrate using a flexible substrate bending test apparatus according to an embodiment. FIG. 11 shows a step-by-step process of bending a flexible substrate three times at a time for a bending test. This bending test may be performed using the stages shown in FIG. 1 or FIG. 6, and will be described below based on the stage shown in FIG. 6. Additionally, in the drawings, movement values are indicated based on the movement amount of the second stage 180.

Step 1: Rotate the second stage 180 by 180 degrees (counterclockwise) around the rotation axis (T-axis) to position the mounting surface 161 of the first stage 160 and the mounting surface 181 of the second stage 180 to face each other in a mutually parallel state.

Step 2: Lower the first stage 160 by 9 mm in the vertical direction (Z-axis direction) to widen the gap between the mounting surface 161 of the first stage 160 and the mounting surface 181 of the second stage 180. At this time, the second stage 180 moves +9 mm in the Z-axis direction with respect to the first stage 160.

Step 3: Rotate the second stage 180 around the T-axis (clockwise) to be in a 160 degrees state.

Step 4: Move the first stage 160 9 mm in the horizontal direction (Y-axis direction) to set the inspection position for bending. At this time, relatively, the second stage 180 moves −9 mm in the Y-axis direction.

Step 5: The first stage 160 is raised 9 mm in the Z-axis direction to press the bent portion of the flexible substrate 30. At this time, relatively, the second stage 180 moves −9 mm in the Z-axis direction.

Step 6: The first stage 160 is lowered 9 mm in the (Z-axis direction) to widen the gap between the mounting surface 161 of the first stage 160 and the inclined surface 186 of the second stage 180. At this time, relatively, the second stage 180 moves +9 mm in the Z-axis direction.

Step 7: Move the first stage 160 by 16 mm in the Y-axis direction to set another inspection position for bending. At this time, relatively, the second stage 180 moves +16 mm in the Y-axis direction.

Step 8: The first stage 160 is raised 9 mm in the Z-axis direction to press the bent portion of the flexible substrate 30. At this time, relatively, the second stage 180 moves −9 mm in the Z-axis direction.

Step 9: The first stage 160 is lowered by 9 mm in the Z-axis direction to widen the gap between the mounting surface 161 of the first stage 160 and the inclined surface 186 of the second stage 180. At this time, relatively, the second stage 180 moves +9 mm in the Z-axis direction.

Step 10: Move the first stage 160 8 mm in the Y-axis direction to set another inspection position for bending. At this time, relatively, the second stage 180 moves −8 mm in the Y-axis direction.

Step 11: The first stage 160 is raised 9 mm in the Z-axis direction to press the bent portion of the flexible substrate 30. At this time, relatively, the second stage 180 moves −9 mm in the Z-axis direction.

Step 12: The first stage 160 is lowered by 9 mm in the Z-axis direction to widen the gap between the mounting surface 161 of the first stage 160 and the inclined surface 186 of the second stage 180. At this time, relatively, the second stage 180 moves +9 mm in the Z-axis direction.

Step 13: Rotate the second stage 180 around the T-axis (counterclockwise) to create a 180 degree state.

Step 14: Raise the first stage 160 by 9 mm in the Z-axis direction to narrow the gap between the mounting surface 161 of the first stage 160 and the mounting surface 181 of the second stage 180. At this time, relatively, the second stage 180 moves −9 mm in the Z-axis direction.

Step 15: Rotate the second stage 180 around the T-axis (clockwise) to create a 0-degree state (unfolded state).

In embodiments, a movement of the second stage 180a in the horizontal direction (Y-axis direction) based on the initial rotation center for bending is not limited the movement of the second stage 180 described above (e.g., −9 mm→+16 mm→−8 mm). In the flexible substrate bending test apparatus according to an embodiment, the relative movement range of the first stage 160 or the second stage 180 may be changed to ±10 mm based on the initial rotation center for bending.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A flexible substrate bending test apparatus comprising:
a first stage and a second stage, which are driven independently of each other to be relatively movable, wherein each of the first stage and the second stage has a mounting surface on which a flexible substrate is mounted;
a first extension part extending from an edge of the first stage; and
a second extension part extending from an edge of the second stage,
wherein when the first stage and the second stage are in an unfolded state, a portion of the first extension part and a portion of the second extension part overlap each other in a direction perpendicular to the mounting surface of the first stage.

2. The flexible substrate bending test apparatus of claim 1, wherein
the first extension part is positioned vertically higher than the second extension part in the unfolded state.

3. The flexible substrate bending test apparatus of claim 1, wherein
the first extension part has a surface parallel to the mounting surface of the first stage.

4. The flexible substrate bending test apparatus of claim 1, wherein
the second extension part has an inclined surface forming an inclined angle with respect to the mounting surface of the second stage.

5. The flexible substrate bending test apparatus of claim 4, wherein
the inclined surface has a flat portion and a curved portion connected to each other.

6. The flexible substrate bending test apparatus of claim 1, wherein
in the unfolded state, the first stage and the second stage are positioned in a way such that the mounting surface of the first stage and the mounting surface of the second stage are on a same plane.

7. The flexible substrate bending test apparatus of claim 1, wherein
the first extension part is thinner than the first stage, and
the second extension part is thinner than the second stage.

8. The flexible substrate bending test apparatus of claim 7, wherein
in the unfolded state, a thickness of the first extension part decreases as being toward the second stage, and a thickness of the second extension part decreases as being toward the first stage.

9. The flexible substrate bending test apparatus of claim 1, wherein
the first stage includes a side portion below the first extension part, and the second extension part includes an end portion in contact with the side portion in the unfolded state.

10. The flexible substrate bending test apparatus of claim 9, wherein
the side portion includes a contact protrusion protruding outward, and an end side surface of the second extension part defines a contact groove in which the contact protrusion is disposed in the unfolded state.

11. The flexible substrate bending test apparatus of claim 10, wherein
when the contact protrusion is disposed in the contact groove in the unfolded state, the first extension part and the second extension part are spaced apart from each other in a vertical direction.

12. The flexible substrate bending test apparatus of claim 1, wherein
each of the first extension part and the second extension part has an opposing surface facing each other in a direction crossing the mounting surface of the first stage.

13. The flexible substrate bending test apparatus of claim 1, wherein
the first extension part is shorter than the second extension part.

14. The flexible substrate bending test apparatus of claim 1, further comprising:
a first driver which moves the first stage in a first direction;
a second driver which moves the first stage in a second direction perpendicular to the first direction; and
a third driver which rotates the second stage around a rotation axis extending in a third direction perpendicular to a plane defined by the first direction and the second direction.

15. A flexible substrate bending test apparatus comprising:
a first stage having a mounting surface on which a flexible substrate is mounted;
a second stage having a mounting surface on which the flexible substrate is mounted and positioned adjacent to the first stage in an unfolded state;
a first extension part extending from an edge of the first stage toward the second stage in the unfolded state;
a second extension part extending from an edge of the second stage toward the first stage in the unfolded state; and
an actuator which drives the first stage and the second stage to move with respect to each other,
wherein in the unfolded state, the first extension part and the second extension part have a portion facing each other in a direction crossing with the mounting surface of the first stage.

16. The flexible substrate bending test apparatus of claim 15, wherein
the first extension part is positioned vertically higher than the second extension part in the unfolded state.

17. The flexible substrate bending test apparatus of claim 15, wherein
the first extension part has a surface parallel to the mounting surface of the first stage.

18. The flexible substrate bending test apparatus of claim 15, wherein
the second extension part has an inclined surface forming an inclined angle with respect to the mounting surface of the second stage.

19. The flexible substrate bending test apparatus of claim 15, wherein
the first stage and the second stage are positioned in a way such that the mounting surface of the first stage and the mounting surface of the second stage are on a same plane in the unfolded state.

20. The flexible substrate bending test apparatus of claim 15, wherein the actuator comprises:
a linear motion driver which relatively moves the first stage or the second stage in a first or second direction perpendicular to each other; and
a rotational motion driver which relatively rotates the first stage or the second stage about a rotation axis extending in a third direction perpendicular to a plane defined by the first and second directions.
